(19) United States
(12) Patent Application Publication
(10) Pub. No.: US 2016/0091757 A1
(43) Pub. Date: Mar. 31, 2016

(54) DISPLAY DEVICE

(71) Applicant: Japan Display Inc., Tokyo (JP)

(72) Inventors: Hirohisa MIKI, Tokyo (JP); Shigesumi ARAKI, Tokyo (JP)

(21) Appl. No.: 14/865,976

(22) Filed: Sep. 25, 2015

(30) Foreign Application Priority Data
Sep. 26, 2014 (JP) 2014-196477

(51) Int. Cl. G02F 1/1335; G02F 1/1368

(52) U.S. Cl. CPC G02F 1/133603; G02F 1/1368; G02F 1/133528; G02F 1/133514; G02F 2001/133614; G02F 2001/133562; G02F 2001/133567

(57) ABSTRACT

The display device includes: an array substrate having an in-cell polarizing layer and a color layer; a counter substrate; a liquid crystal layer; a white light source; and a polarizing plate placed on the counter substrate on its one side opposite to a side on which the liquid crystal layer is provided. The color layer includes a red color layer, a green color layer and a blue color layer. The red color layer includes a red color filter and a red wavelength conversion layer which is located on its one side closer to the white light source than the red color filter. The green color layer includes a green color filter and a green wavelength conversion layer which is located on its one side closer to the white light source than the green color filter. The blue color layer includes a blue color filter.

### CLAIM OF PRIORITY

The present application claims priority from Japanese patent application JP2014-196477 filed on Sep. 26, 2014, the content of which is hereby incorporated by reference into this application.

### BACKGROUND

This disclosure relates to a display device and is applicable to, for example, to a display device having fluophors or quantum dots in a color layer.

In normal display devices, light of a white light source is split into red (R), green (G) and blue (B) by color filters (hereinafter, referred to as white light source method). In this case, light other than desired light is absorbed by a color layer of color filters in the mainstream method. Other than the white light source method, there have been proposed color layers that are free from absorption of light by virtue of using fluophors or semiconductor quantum dots with the blue color or light of shorter wavelengths than the blue color used as a source light (excitation light) (hereinafter, referred to as blue light source method).

As a related art associated with this disclosure, Japanese Patent laid-open publication H8-171012 is known, for example.

### SUMMARY OF THE INVENTION

In display screen-mounted electronic equipment to be used for mobile use typified by present-day smartphones or tablets, there have been made developments for elongating continuous working time by reducing the power consumption. Displays, which occupy a high ratio of power consumption among other component parts, are considered to be further developed toward electric economization even from this on.

An electric power saving and economization can be realized by enhancing the light use efficiency. The blue light source method is, in terms of principle, higher in light use efficiency than the white light source method, making it desired to establish technology therefor. However, as the white light source method shows remarkable characteristic improvements, the blue light source method cannot fulfill its superiority enough.

An object of this disclosure is to provide a display device capable of enhancing the light use efficiency in a system configuration based on the white light source method.

Other objects and novel features of the disclosure will become apparent from the description of this disclosure and its accompanying drawings.

Typical features of this disclosure can be summarized briefly as follows.

That is, the display device comprises: an array substrate having a pixel electrode, an in-cell polarizing layer, a color layer, a semiconductor layer of pixel transistors, and a first glass substrate; a counter substrate having a second glass substrate; a liquid crystal layer placed between the array substrate and the counter substrate; a white light source placed on one side closer to the array substrate; and a polarizing plate placed on the counter substrate on its one side opposite to a side on which the liquid crystal layer is provided. The color layer includes a red color layer, a green color layer and a blue color layer. The red color layer includes a red color filter and a red wavelength conversion layer which is located on its one side closer to the white light source than the red color filter. The green color layer includes a green color filter and a green wavelength conversion layer which is located on its one side closer to the white light source than the green color filter. The blue color layer includes a blue color filter. The red color filter absorbs light other than red color, the green color filter absorbs light other than green color, and the blue color filter absorbs light other than blue color. The red wavelength conversion layer converts blue light of the white light source into red color, and the green wavelength conversion layer converts blue light of the white light source into green light.

### BRIEF DESCRIPTION OF THE DRAWINGS

FIG. 1 is a sectional view for explaining a display device according to Comparative Example 1;

FIG. 2 is a sectional view for explaining a display device according to Comparative Example 2;

FIG. 3 is a view for explaining light use efficiency of the display device according to Comparative Example 1;

FIG. 4 is a view for explaining light use efficiency of a display device according to embodiments;

FIG. 5 is a sectional view for explaining a display device according to Embodiment 1;

FIG. 6 is a sectional view for explaining a color layer of the display device according to Embodiment 1;

FIG. 7 is a sectional view for explaining a display device according to Embodiment 2;

FIG. 8 is a sectional view for explaining a configuration of a display device according to Modification 1;

FIG. 9 is a sectional view for explaining a configuration of a display device according to Modification 2;

FIG. 10 is a sectional view for explaining a makeup of a display device according to Modification 3;

FIG. 11 is a plan view for explaining a display device according to a working example;

FIG. 12 is a sectional view for explaining a display device according to Example 1;

FIG. 13 is a sectional view for explaining the display device according to Example 1;

FIG. 14 is a sectional view for explaining a display device according to Example 2; and

FIG. 15 is a sectional view for explaining the display device according to Example 2.

### DESCRIPTION OF THE PREFERRED EMBODIMENTS

Hereinbelow, embodiments, comparative examples, modifications and working examples of the present invention will be described with reference to the accompanying drawings. It is noted that the disclosure is presented only as an example, and changes and modifications without departing the gist of the invention, which those skilled in the art could easily have been conceived, should be construed as being included in the scope of the invention as a matter of course. Also, the accompanying drawings are depicted schematically in terms of width, thickness, configuration and the like of individual parts as compared with actual aspects for clearer explanation, but this is only an example and is not limitative for interpretation of the invention. Further, throughout the specification and the accompanying drawings, the same members as those already described in connection with already mentioned figures are designated by the same reference signs and their detailed description may be omitted as appropriate.

### Comparative Examples

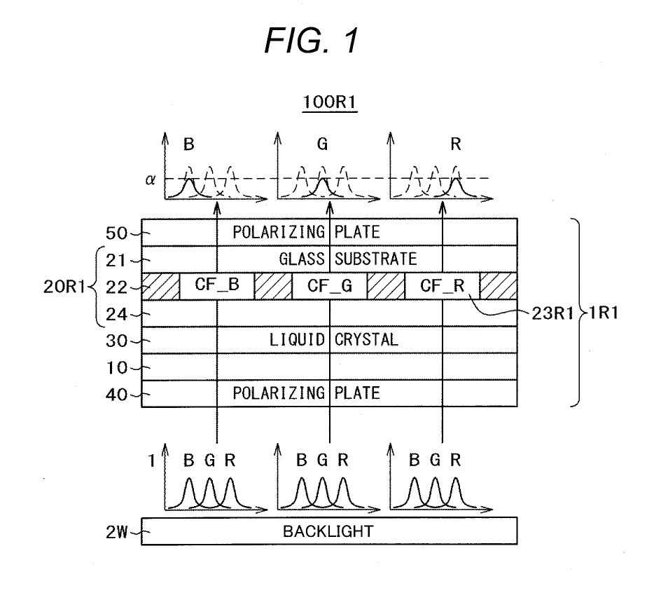

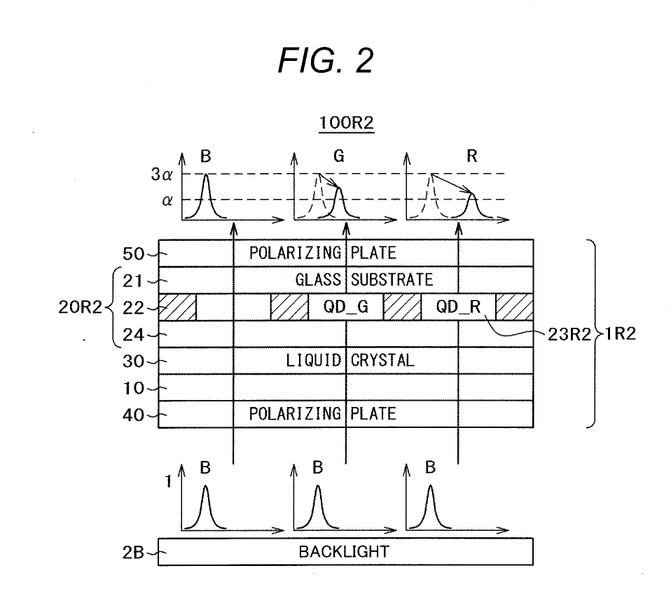

First described below by referring to FIGS. 1 and 2 are a display device (hereinafter, referred to as Comparative Example 1) with use, in a color layer, of color filters that have been discussed prior to the disclosure of this application, as well as a display device (hereinafter, referred to as Comparative Example 2) with use of wavelength conversion layers in the color layer.

FIG. 1 is a sectional view for explaining the display device according to Comparative Example 1. FIG. 2 is a sectional view for explaining the display device according to Comparative Example 2.

The display device 100R1 according to Comparative Example 1 includes a display panel 1R1 with color filters CF_B, CF_G, CF_R used in a color layer 23R1, and a white-light-source backlight 2W. The display panel 1R1 includes an array substrate 10, a counter substrate 20R1 and a liquid crystal layer 30. The array substrate 10 has a polarizing plate 40 positioned on its one side opposite to the liquid crystal layer 30. The counter substrate 20R1 has a light shield layer 22, a color layer 23R1 and an overcoat film 24 on its one side on which the liquid crystal layer 30 is provided. The counter substrate 20R1 has a polarizing plate 50 positioned on its one side opposite to the liquid crystal layer 30 side.

A display device 100R2 according to Comparative Example 2 includes a display panel 1R2 with a green wavelength conversion layer QD_G and a red wavelength conversion layer QD_R used in a color layer 23R2, and a blue-light-source backlight 2B. It is noted that a blue color layer allows the source light to be transmitted therethrough without using any wavelength conversion layer. The display panel 1R2 includes an array substrate 10, a counter substrate 20R2 and a liquid crystal layer 30. The array substrate 10 has a polarizing plate 40 positioned on its one side opposite to the liquid crystal layer 30. The counter substrate 20R2 has a light shield layer 22, a green wavelength conversion layer QD_G, and a red wavelength conversion layer QD_R on its one side on which the liquid crystal layer is provided. The green wavelength conversion layer QD_G and the red wavelength conversion layer QD_R convert blue source light into green light and red light, respectively. The counter substrate 20R2 has a polarizing plate 50 positioned on its one side opposite to the liquid crystal layer 30 side.

The display device 100R1 according to Comparative Example 1 absorbs unwanted right by the color filters of the color layer 23R1 in order to extract desired light. For example, out of white light incident on the color filter CF_G, green light is transmitted by the filter while blue light and red light are absorbed, thus color development being fulfilled. This is the case also with the color filters CF_G and CF_R. Further, as shown in FIG. 1, part of necessary light is absorbed during the passage through the display panel 1R1. In this case, light use efficiency of the display device 100R1 is assumed as α (<1). Meanwhile, the display device 100R2 according to Comparative Example 2 involves no absorption by the color layer 23R2, offering an expectation for high efficiency, in principle. That is, as shown in FIG. 2, the light use efficiency is 3α for blue (B) and 3α×(wavelength conversion efficiency) for both green (G) and red (R). However, the wavelength conversion efficiency by the wavelength conversion layer using quantum dots or the like is under development, not yet having reached any light use efficiency beyond those of color filters at the present time.

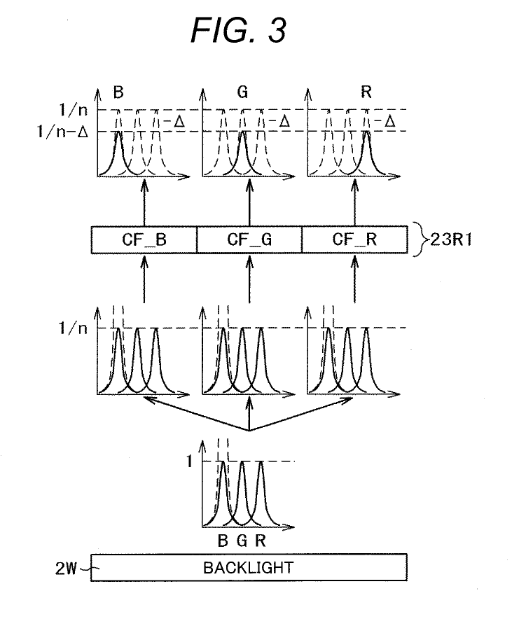

FIG. 3 is a view for explaining light use efficiency of the display device according to Comparative Example 1.

On the assumption that the number of sub-pixels per pixel is n, then each pixel has about 1/n light incident on each sub-pixel. Accordingly, a brightness of each sub-pixel is 1/n-Δ, where Δ represents a quantity of necessary light absorbed by color layers or the like. It is noted that the backlight 2W has spectral characteristics containing the whole wavelength range of visible light. The display device according to Comparative Example 1 has pixels composed of R, G and B, where the number of sub-pixels is 3 (n=3). Hence, α=⅓−Δ. It is noted that combination and number of colors in color layers are not limited to the above ones.

### Embodiments

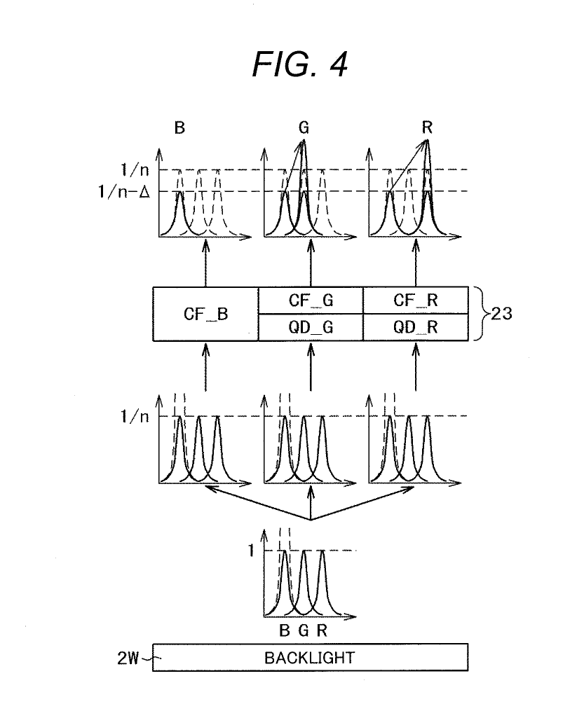

FIG. 4 is a view for explaining light use efficiency of a display device according to embodiments.

As described above, out of white light incident on the color filter CF_G, green light is transmitted by the filter while blue light and red light are absorbed, thus color development being fulfilled. In the display device according to the embodiments, the blue light to be absorbed during the above process is converted into green light or red light by quantum dots or fluophor before the incidence on the color filters so that the light quantity of green or red to be extracted is increased. On the assumption that the number of sub-pixels per pixel is n as in the case of FIG. 3, about 1/n light becomes incident on each sub-pixel. Therefore, as shown in FIG. 4, the brightness of each sub-pixel for other than blue light in the display device according to the embodiments is 1/n (1+internal quantum efficiency×external quantum efficiency). In addition, since green light or red light of longer wavelength generally cannot be converted into blue light of shorter wavelength by quantum dots or fluophor, blue light is fulfilled by using the color filter CF_B alone in the display device according to the embodiments.

The display device according to the embodiments can be increased in efficiency by effectively utilizing the light of absorption loss on the basis of the display device according to Comparative Example 1. The display device according to the embodiments, which is built up on the display device according to Comparative Example 1, is improved in luminance. If the forward extraction efficiency of the wavelength conversion layer is 20%, then the display device according to the embodiments is increased by 10% in efficiency than the display device according to Comparative Example 1. Also, if the forward extraction efficiency of the wavelength conversion layer is 50%, then the display device according to the embodiments is increased by 30% in efficiency as compared with the display device according to Comparative Example 1.

The display device according to the embodiments will be described below in more detail.

### Embodiment 1

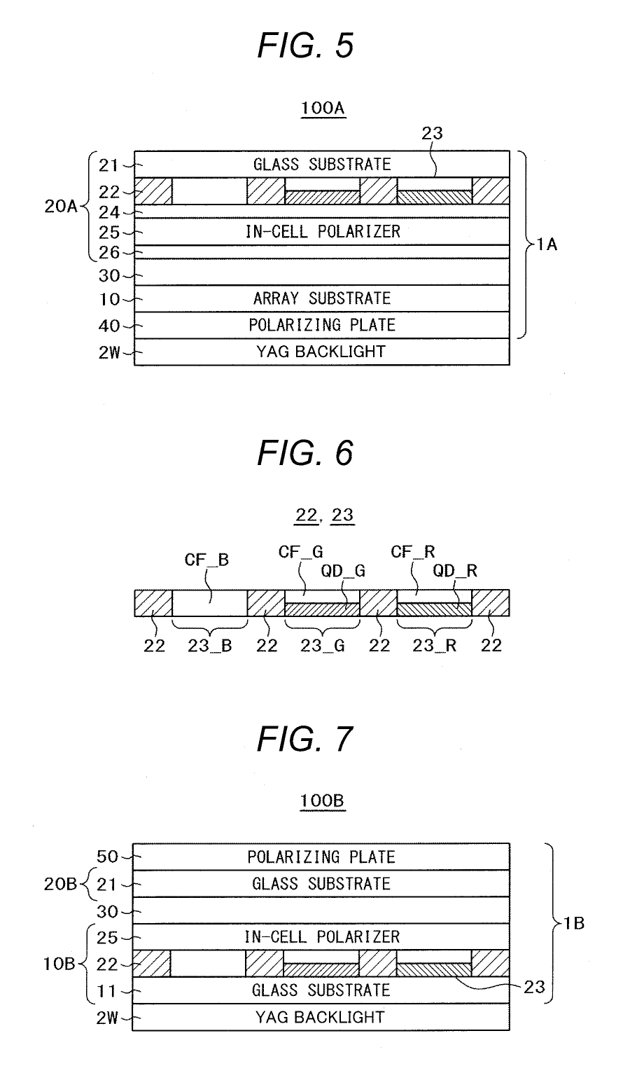

A display device according to a first embodiment (Embodiment 1), in which a color layer is included in the counter substrate, will be described below with reference to FIGS. 5 and 6.

FIG. 5 is a sectional view for explaining the display device according to Embodiment 1. FIG. 6 is a sectional view for explaining the color layer of the display device according to Embodiment 1.

The display device 100A according to Embodiment 1 includes a display panel 1A and a white-light-source backlight 2W. The display panel 1A includes an array substrate 10, a counter substrate 20A and a liquid crystal layer 30. The display panel 1A has a polarizing plate 40 positioned on one side of the array substrate 10 opposite to the side on which the liquid crystal layer 30 is provided. The array substrate 10 includes TFTs (Thin Film Transistors), pixel electrodes and an orientation film, which are not shown. The counter substrate 20A has a light shield layer 22, a color layer 23, an overcoat film 24, an in-cell polarizer 25 and an overcoat film 26 on a glass substrate 21. The counter substrate 20A includes an orientation film and a columnar spacer which are not shown.

The color layer 23 is interposed between the glass substrate 21 and the in-cell polarizer 25. The color layer 23 includes a red color layer 23_R, a green color layer 23_G and a blue color layer 23_B. A light shield layer 22 is provided between each two of the red color layer 23_R, the green color layer 23_G and the blue color layer 23_B. The red color layer 23_R includes a red color filter CF_R and a wavelength conversion layer QD_R for converting blue light into red light. The green color layer 23_G includes a green color filter CF_G and a wavelength conversion layer QD_G for converting blue light into green light. The blue color layer 23_B includes a blue color filter CF_B. The red color filter CF_R, the green color filter CF_G and the blue color filter CF_B are resin layers which contain their respective color-material pigments and which absorb light other than the red color, light other than the green light and light other than the blue light, respectively. The red wavelength conversion layer QD_R and the green wavelength conversion layer QD_G have fluophor or quantum dots or the like in their resin layers, respectively. The quantum dots are nano-sized semiconductor particles, which allow their luminescent colors to be adjusted only by changing the size and which feature in generally uniform quantum yields and narrow luminescent bands, having excellent color purities. The red wavelength conversion layer QD_R and the green wavelength conversion layer QD_G are placed closer to the light source than the red color filter CF_R and the green color filter CF_G, respectively.

The in-cell polarizer 25 is placed so as to be sandwiched by the overcoat layers 24, 25 between the color layer 23 and the liquid crystal layer 30. The in-cell polarizer 25 is a wire grid or a coat-type polarizing plate or the like.

In addition, as shown in FIG. 5, the red wavelength conversion layer QD_R and the green wavelength conversion layer QD_G, in which fluophor or quantum dots have been dispersed, are placed on one side opposite to the side on which the in-cell polarizer 25 and the liquid crystal layer 30 located on the inner side of the polarizing plate 40 are provided, i.e., placed on the outer side. This placement is due to the following reason.

Normally, in liquid crystal display devices, linearly polarized light incident on one polarizing plate is controlled by orientation of liquid crystal molecules so that only polarized light coincident with a transmission axis of a counter polarized light (light-outgoing side polarized light) is transmitted to fulfill display. However, on the ground that light emitted from the fluophor or quantum dots is omnidirectionally scattered light, in a case where wavelength conversion layers are placed in a space in which linearly polarized light is controlled, i.e. between two polarizing plates, polarized light subjected to the control is disturbed, giving a large influence on the display. Particularly in black display, there occur light leaks, making a large cause of contract degradation. Accordingly, the wavelength conversion layers necessarily need to be placed outside the polarizing plates.

As the white light source, a white LED (Light Emitting Diode) is used as an example, and the white LED is a combination of a blue LED and a yellow fluophor (yttrium aluminum garnet (YAG)).

### Embodiment 2

A display device according to a second embodiment (Embodiment 2) having a color layer in the array substrate will be described below with reference to FIGS. 6 and 7.

FIG. 7 is a sectional view for explaining a display device according to Embodiment 2.

The display device 100B according to Embodiment 2 includes a display panel 1B and a white-light-source backlight 2W. The display panel 1B includes an array substrate 10B, a counter substrate 20B (glass substrate 21), and a liquid crystal layer 30. The display panel 1B has a polarizing plate 50 positioned on one side of the counter substrate 20B opposite to the side on which the liquid crystal layer 30 is provided. The array substrate 10B includes a glass substrate 11, a light shield layer 22, a color layer 23 and an in-cell polarizer 25.

The color layer 23 includes a red color layer 23_R, a green color layer 23_G and a blue color layer 23_B. A light shield layer 22 is provided between each two of the red color layer 23_R, the green color layer 23_G and the blue color layer 23_B. The red color layer 23_R includes a red color filter CF_R and a red wavelength conversion layer QD_R. The green color layer 23_G includes a green color filter CF_G and a green wavelength conversion layer QD_G. The blue color layer 23_B includes a blue color filter CF_B.

The in-cell polarizer 25 is placed so as to be sandwiched between the color layer 23 and the liquid crystal layer 30. In addition, as shown in FIG. 7, the color layer 23 including the red wavelength conversion layer QD_R and the green wavelength conversion layer QD_G is placed on one side opposite to the side on which the in-cell polarizer 25 and the liquid crystal layer 30 located on the inner side of the polarizing plate 50 are provided, i.e., placed on the outer side. This placement is due to the following reason.

As the white light source, a white LED is used as an example, and the white LED is a combination of a blue LED and a YAG.

### Modification 1

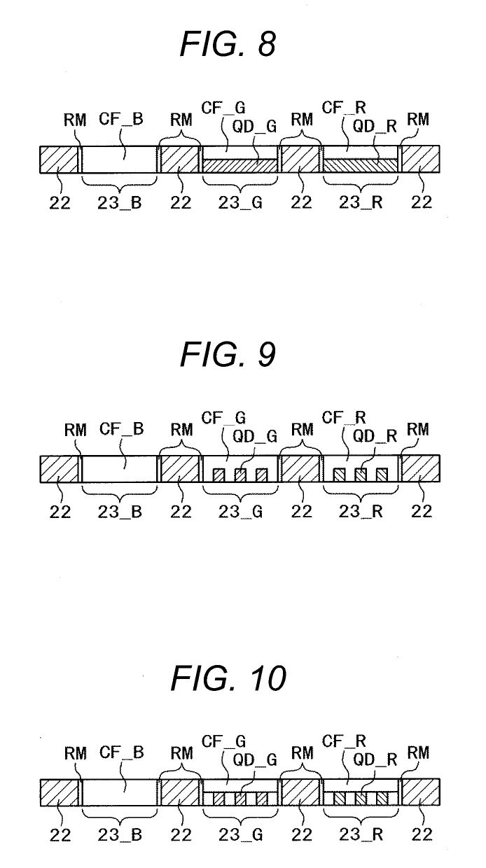

A first modification example (Modification 1) of the color layer in the display device according to Embodiment 1 or Embodiment 2 will be described with reference to FIG. 8.

FIG. 8 is a sectional view for explaining the color layer according to Modification 1.

A reflective film RM is provided between the light shield layer 22 and each of the red color layer 23_R, the green color layer 23_G and the blue color layer 23_B. The rest of the configuration other than this feature is similar to that of the embodiments. Although scattering of light by the fluophor and the quantum dots of the red wavelength conversion layer QD_R and the green wavelength conversion layer QD_G may cause scattering of light that could be expected to be transmitted therethrough, yet the scattered light can be made to be transmitted by the reflective film RM.

### Modification 2

A second modification example (Modification 2) of the color layer in the display device according to Embodiment 1 or Embodiment 2 will be described with reference to FIG. 9.

FIG. 9 is a sectional view for explaining the color layer according to Modification 2.

In Modification 2, unlike Modification 2, the red wavelength conversion layer QD_R and the green wavelength conversion layer QD_G are laid down not without gaps but with spaces partly provided therein. A color filter is filled in a cleared space. As a result of this, a path that allows the source light to be transmitted without being scattered can be ensured.

### Modification 3

A third modification example (Modification 3) of the color layer in the display device according to Embodiment 1 or Embodiment 2 will be described with reference to FIG. 10.

FIG. 10 is a sectional view for explaining the color layer according to Modification 3.

In Modification 3, unlike Modification 2, a transparent resin is filled in partly cleared spaces in the red wavelength conversion layer QD_R and the green wavelength conversion layer QD_G. As a result of this, a path that allows the source light to be transmitted without being scattered can be ensured.

In addition, pigments of the color filters may be mixed up in the wavelength conversion layers in any of Embodiment 1, Embodiment 2 and Modifications 1 to 3. Also, for enhancement of the light extraction efficiency, the wavelength conversion layers may be so formed that their junction surfaces with pigment color materials of the color filters are bombshell-shaped (upwardly projective) or moth eye-shaped (upwardly projective) or the like. Further, the wavelength conversion layers may include second, third scatterers for converting light other than the blue light with a view to efficiently utilizing excitation light.

The color filters, when extracting particular wavelengths, absorb and split wavelengths to be eliminated. In Embodiment 1 and Embodiment 2, light of a wavelength band for absorption is subject, before being absorbed, to wavelength conversion by using the wavelength conversion layers provided in layers below the color layer of the color filters so that the light is converted to a wavelength band of higher pigment transmissivity, thus making it possible to reduce optical loss due to the absorption and amplify wavelength bands of higher visibility. Embodiment 1 and Embodiment 2, which are basically configured on the white light source method, can surpass, in light use efficiency, methods in which only color filters are used in all cases.

The liquid crystal display mode for carrying out Embodiment 1 and Embodiment 2 is not limitative. The mode may be the TN (Twisted Nematic) method in which liquid crystal molecules are switched by using electric fields generally vertical to the substrate plane, the VA (Vertical Alignment) method, the IPS (In Plane Switching) method in which liquid crystal molecules are switched by using electric fields generally parallel to the substrate plane, the FFS (Fringe Field Switching) method in which electrodes for driving liquid crystals are superimposed within pixels so that liquid crystals are switched by fringe electric fields in proximity to the electrodes, and the like. Furthermore, display devices for carrying out Embodiment 1 and Embodiment 2 are not limited to liquid crystal display devices, and those embodiments may be applied also to organic electroluminescence display devices using color filters.

### Example 1

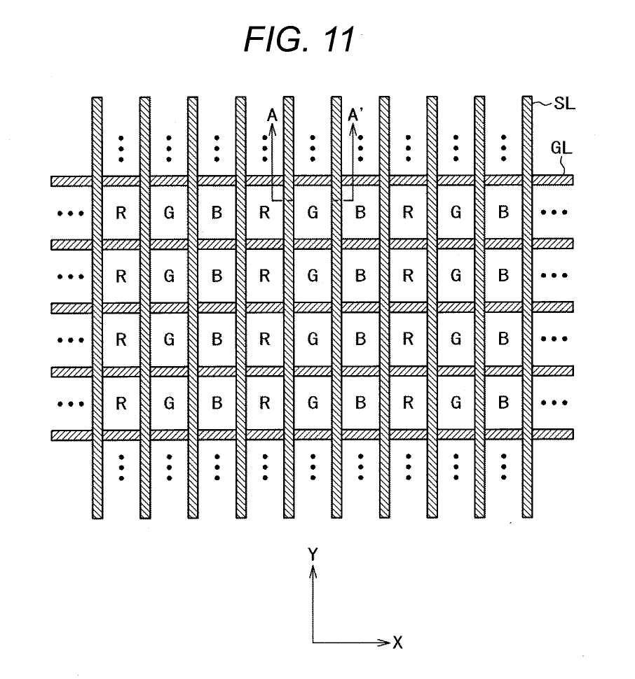

A first example (Example 1) of the display device according to Embodiment 2 will be described with reference to FIGS. 11 to 13.

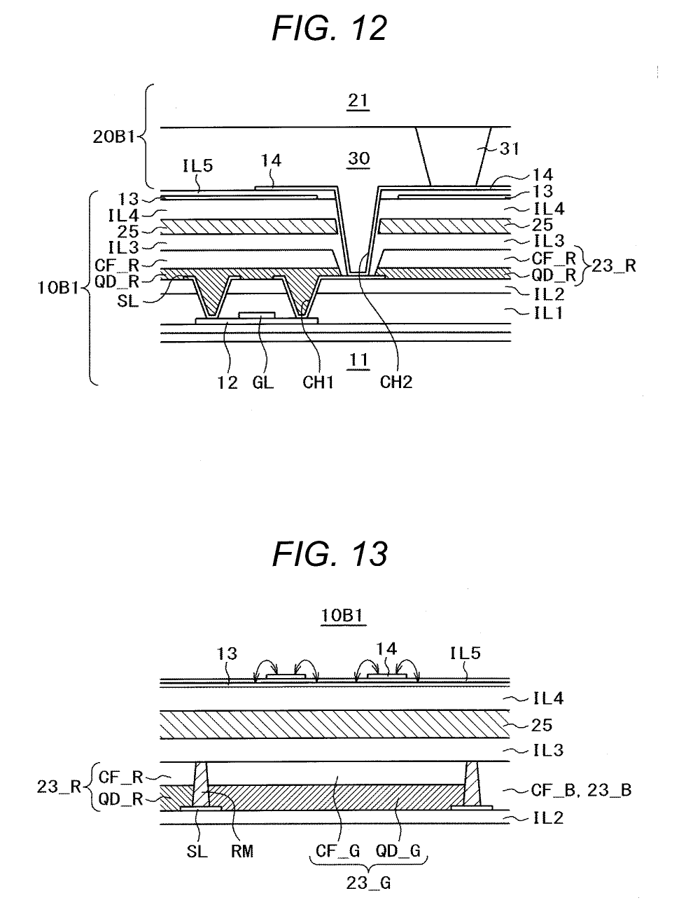

FIG. 11 is a plan view for explaining a structure of a display device according to Example 1. FIG. 12 is a sectional view of a TFT contact hole portion for explaining a structure of a display device according to Example 1. FIG. 13 is a sectional view of a pixel central portion for explaining the display device according to Example 1. FIG. 13 is a sectional view taken along a line A-A′ of FIG. 11.

The display device according to Example 1 includes longitudinal stripe-shaped sub-pixels of red (R), green (G) and blue (B), which are arranged on the unit of RGB as one pixel. The color layer 23 may be such that R, G and B are repeatedly placed in this order in a row direction (X direction) while identical colors are set along the column direction (Y direction) of the color layer 23. A gate line GL extends in the X direction, and a source line SL extends in the Y direction.

The array substrate 10B1 includes a TFT 12, a signal line SL, a scan line GL, a color layer 23, an in-cell polarizing layer (in-cell polarizer) 25, a common electrode 13, a pixel electrode 14 and the like provided on a first substrate 11 made from glass. The color layer 23 is provided on the source line SL and an insulating film IL2. A red color layer 23_R, a green color layer 23_G and a blue color layer 23_B are similar to those described in embodiments, respectively. The red color layer 23_R is so made up that a red color filter CF_R is formed on a red wavelength conversion layer QD_R. The green color layer 23_G is so made up that a green color filter CF_G is formed on a green wavelength conversion layer QD_G. The blue color layer 23_B is formed of a blue color filter CF_B. A reflective metal (light shield layer) RM is provided between each two of the red color layer 23_R, the green color layer 23_G and the blue color layer 23_B. An in-cell polarizing layer 25 is provided via an insulating film IL3 on the color layer 23. The common electrode 13 is provided via an insulating film IL4 on the in-cell polarizing layer 25. The pixel electrode 14 is provided via an insulating film IL5 on the common electrode 13. The common electrode 13 and the pixel electrode 14 are formed from ITO (Indium Tin Oxide) excellent in transparency and electroconductivity. The signal line SL and the scan line GL intersect each other, where a TFT 12 is provided in proximity to the intersecting part in one-to-one correspondence to the pixel electrode 14. A voltage responsive to an image signal is applied from the signal line SL via the TFT 12 and contact holes CH1, CH2 to the pixel electrode 14, so that operations of the TFT 12 are controlled by scan signals of the scan line GL. A channel region of the TFT 12 is formed of an amorphous silicon layer (semiconductor layer) or, otherwise, may also be formed of a polysilicon layer (semiconductor layer) of high mobility. An unshown first orientation film is provided on one side of the pixel electrode 14 closer to the liquid crystal layer 30. The first orientation film is an polyimide-based organic polymer membrane having been orientation treated in a specified orientation.

A counter substrate 20B1 is made up of a roughly columnar-shaped post spacer (pillar-shaped spacer) 31 and an unshown second orientation film, where the post spacer 31 is provided on one side of the glass-made second substrate 21 closer to the liquid crystal layer 30. The second orientation film, like the first orientation film, is a polyimide-based organic polymer membrane having been orientation treated in a specified orientation.

The array substrate 10B1, in which the color layer 23 and the in-cell polarizing layer 25 have been disposed, and the counter substrate 20B1 are assembled up, with their gap maintained uniform by the pillar-shaped spacer 31 placed on one side closer to the counter substrate 20B1. A liquid crystal material is sealed in this gap.

On the upper side (side closer to an observer) of the counter substrate 20B, such a polarizing plate 50 as shown in FIG. 7 is placed. The in-cell polarizing layer 25 and the polarizing plate 50 are so placed that their absorption axes orthogonally intersect to each other as observed in a normal-to-plane direction and moreover the absorption axis of the polarizing plate 50 is set parallel to a liquid-crystal orientation direction in the second orientation film. On the lower side (the side counter to the observer) of the array substrate 10B1, an unshown backlight (illuminating device) having a white light source is provided.

### Example 2

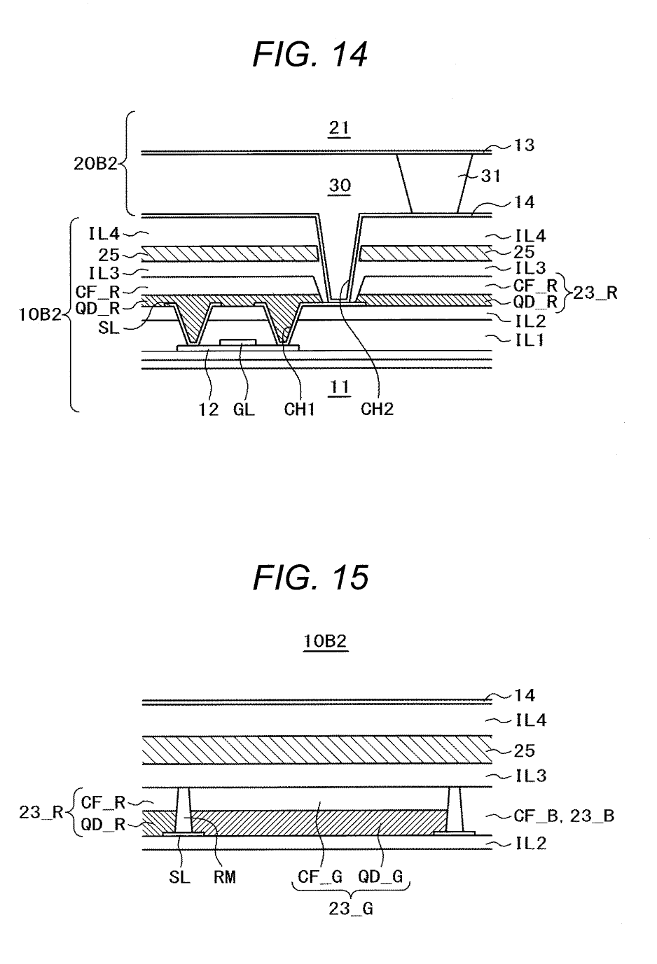

A second example (Example 2) of the display device according to Embodiment 2 will be described with reference to FIGS. 14 and 15.

FIG. 14 is a sectional view of a TFT contact hole portion for explaining a structure of a display device according to Example 2. FIG. 15 is a sectional view of a pixel central portion for explaining the structure of the display device according to Example 2.

The display device according to Example 2 is similar to the display device according to Example 1 except that in the display device of Example 2, the common electrode 13 is formed on a counter substrate 10B2 with the insulating film IL5 resultantly eliminated.

That is, the array substrate 10B2 includes a TFT 12, a signal line SL, a scan line GL, a color layer 23, an in-cell polarizing layer 25, a pixel electrode 14 and the like provided on a first substrate 11 made from glass. The pixel electrode 14 is formed via the insulating film IL4 on the in-cell polarizing layer 25.

A counter substrate 20B2 is made up of a roughly columnar-shaped post spacer (pillar-shaped spacer) 31 and an unshown second orientation film, where the post spacer 31 is provided on one side of the glass-made second substrate 21 closer to the liquid crystal layer 30.

1. A display device comprising:
an array substrate having a pixel electrode, an in-cell polarizing layer, a color layer, a semiconductor layer of pixel transistors, and a first glass substrate;
a counter substrate having a second glass substrate;
a liquid crystal layer placed between the array substrate and the counter substrate;
a white light source placed on one side closer to the array substrate; and
a polarizing plate placed on the counter substrate on its one side opposite to a side on which the liquid crystal layer is provided, wherein
the color layer includes a red color layer, a green color layer and a blue color layer,
the red color layer includes a red color filter and a red wavelength conversion layer which is located on its one side closer to the white light source than the red color filter,
the green color layer includes a green color filter and a green wavelength conversion layer which is located on its one side closer to the white light source than the green color filter,
the blue color layer includes a blue color filter,
the red color filter absorbs light other than red color,
the green color filter absorbs light other than green color,
the blue color filter absorbs light other than blue color,
the red wavelength conversion layer converts blue light of the white light source into red color, and
the green wavelength conversion layer converts blue light of the white light source into green light.

2. The display device as claimed in claim 1,
wherein the red wavelength conversion layer has fluophor or quantum dots, and
the green wavelength conversion layer has fluophor or quantum dots.

3. The display device as claimed in claim 2, wherein the pixel electrode, the in-cell polarizing layer, the color layer, the semiconductor layer, and the first glass substrate are placed in this order as listed from the liquid crystal layer side.

4. The display device as claimed in claim 3, wherein the array substrate has a common electrode in a layer between the pixel electrode and the in-cell polarizing layer.

5. The display device as claimed in claim 4, wherein the array substrate has an orientation film between the liquid crystal layer and the pixel electrode.

6. The display device as claimed in claim 5, wherein the counter substrate has a spacer and an orientation film.

7. The display device as claimed in claim 3, wherein the in-cell polarizing layer is a wire grid or a coat-type polarizer.

8. The display device as claimed in claim 3, wherein the counter substrate has a common electrode.

9. The display device as claimed in claim 1, wherein the white light source is composed of a blue LED and YAG.

10. The display device as claimed in claim 1, wherein a light shield layer is provided between the red color layer and the green color layer, between the green color layer and the blue color layer, and between the blue color layer and the red color layer.

11. A display device comprising:
an array substrate;
a counter substrate having a second glass substrate, a color layer, and an in-cell polarizing layer;
a liquid crystal layer placed between the array substrate and the counter substrate;
a white light source placed on one side closer to the array substrate; and
a polarizing plate placed on the counter substrate on its one side opposite to a side on which the liquid crystal layer is provided, wherein
the color layer includes a red color layer, a green color layer and a blue color layer,
the red color layer includes a red color filter and a red wavelength conversion layer which is located on its one side closer to the white light source than the red color filter,
the green color layer includes a green color filter and a green wavelength conversion layer which is located on its one side closer to the white light source than the green color filter,
the blue color layer includes a blue color filter,
the red color filter absorbs light other than red color,
the green color filter absorbs light other than green color,
the blue color filter absorbs light other than blue color,
the red wavelength conversion layer converts blue light of the white light source into red color, and
the green wavelength conversion layer converts blue light of the white light source into green light.

12. The display device as claimed in claim 11, wherein
the red wavelength conversion layer has fluophor or quantum dots, and
the green wavelength conversion layer has fluophor or quantum dots.

13. The display device as claimed in claim 12, wherein the in-cell polarizing layer, the color layer, and the second glass substrate are placed in this order as listed from the liquid crystal layer side.

14. The display device as claimed in claim 13, wherein the counter substrate has an overcoat layer between the color layer and the in-cell polarizing layer.

15. The display device as claimed in claim 14, wherein the array substrate has an orientation film.

16. The display device as claimed in claim 15, wherein the counter substrate has a spacer and an orientation film.

17. The display device as claimed in claim 13, wherein the in-cell polarizing layer is a wire grid or a coat-type polarizer.

18. The display device as claimed in claim 11, wherein the array substrate has a TFT, a pixel electrode and a common electrode.

19. The display device as claimed in claim 11, wherein the white light source is composed of a blue LED and YAG.

20. The display device as claimed in claim 11, wherein a light shield layer is provided between the red color layer and the green color layer, between the green color layer and the blue color layer, and between the blue color layer and the red color layer.
